(19) United States
(12) Patent Application Publication
(10) Pub. No.: US 2011/0078281 A1
(43) Pub. Date: Mar. 31, 2011

(54) LAWFUL ACCESS DATA RETENTION DIAMETER APPLICATION

(76) Inventors: Amedeo Imbimbo, Caivano (NA) (IT); Giuseppe Carnevale, Napli (IT)

(21) Appl. No.: 12/994,667

(22) PCT Filed: May 27, 2008
(86) PCT No.: PCT/EP2008/056475

§ 371 Date: Nov. 24, 2010

(51) Int. Cl. G06F 17/30; G06F 15/16

(52) U.S. Cl. 709/217

(57) ABSTRACT

A telecommunications network having at least one Data Retention Source and a Data Retention system adapted to communicate with the Data Retention Source and with a lawful requesting authority. The Data Retention Source is configured as a Diameter client and the Data Retention system is configured as a Diameter server. The Data Retention Source comprises means for generating at least one report containing data related to a communication session and means for sending such report to the Data Retention system as a Diameter message using a Data Retention Diameter application protocol.

### TECHNICAL FIELD

The present invention relates to methods and arrangements in a telecommunications network comprising a Data Retention system for storing call and service data which can be accessed by a lawful requesting authority.

### BACKGROUND

In many countries operators and communication service providers are today obliged by legal requirements to provide stored traffic data generated from public telecommunications, mobile and Internet networks for the purpose of detection, investigation and prosecution of crime and criminal offences, including terrorism.

This data is normally stored in repositories at communication service providers, which are accessible by lawful authorities through suitable interfaces.

FIG. 1 depicts a known arrangement for retaining data in a Communication Service Provider (CSP) 14. The CSP 14 comprises a Data Retention (DR) system 16 for exchanging retained data related information with a Requesting Authority 15.

The data exchanged between the CSP 14 and the Requesting Authority 15 comprises requests from the Requesting Authority 15, corresponding responses from the DR system 16 and other DR information, such as results of the requests and acknowledgements of receipt.

The CSP 14 and the DR system 16 communicate with the Requesting Authority 15, which may be a Lawful Enforcement Authority (LEA), by means of Handover Interfaces HI-A 11 and HI-B 12. The HI-A 11 is adapted to transport various kinds of administrative, request and response information from/to the Requesting Authority 15 and the organization at the CSP 14, which is responsible for retained data matters. The HI-A interface may be crossing borders between countries. This may require different configuration according to national law and/or international agreements.

The HI-B 12 is adapted to transmit the retained data stored in the storage 10 from the CSP 14 to the Requesting Authority 15. The retained data parameters have to be sent to the requesting authority at least once (if available). Also HI-B may be crossing borders between countries.

The increase in size and functionalities of modern telecommunications networks such as mobile networks has also increased the number of information which should be retrieved and retained in DR systems. In particular, mobile telecommunications networks are now giving subscribers the possibility of exploiting many services in addition to normal calls, such as call forward service, IP services and multimedia services.

The size and complexity of mobile networks, together with the high number of users involved, brought service providers to use the Diameter protocol as AAA (Authentication, Authorization and Accounting) protocol.

FIG. 2 illustrates a high-level overview of the Diameter protocol architecture. The Diameter protocol has been implemented as an extension of the RADIUS protocol, which is normally used for communication between points of entry into communications networks such as NASs (Network Access Servers) and AAA servers attached to the communications networks, which act as central repository for storing and distributing AAA information to the points of entry.

Diameter is defined in terms of a base protocol 1 and a set of applications extending the capabilities of the diameter base protocol 1. Thus, the “open” design of the Diameter protocol allows the base protocol 1 to be extended to current or future access technologies.

The base protocol 1 provides basic mechanisms or methods for reliable data transport, message delivery and error handling. Instead, each Diameter application relies on the services provided by the Diameter base protocol 1 to support a specific type of network access. Such applications may be a Cryptographic Message Syntax CMS application 2, a NASREQ application 3 or a Mobile IPv4 application 4. Other applications currently used together with the base diameter protocol are the Diameter Extensible Authentication Protocol Application, the Diameter Credit-Control Application, the Diameter Session Initiation Protocol Application and various applications in a 3GPP IP Multimedia Subsystem.

As of the time of this disclosure, network elements do not fulfill the data retention requirements entirely. Only the charging interfaces could be used to retrieve all call-related data, but they convey only information which is used for billing and credit control purposes.

Therefore, the traffic nodes in a telecommunications network are often not configured to send some specific information available to them. For instance, the information about unsuccessful call data or terminated calls are available to the traffic nodes involved, but is not relevant for the charging interface and is accordingly never used. In some cases it may be possible to generate the missing data, after the proper node configuration settings. The node itself or an intermediate mediation function may duplicate the information both to the billing system and to the data retention system and possibly filter out the unneeded information (like terminating calls) before sending it to the billing system. This filtering could be not feasible to implement in this intermediate mediation function, because it may depend on charging subscriber basis options.

As another example, in wireless circuit-switched and wired networks the output of data related to supplementary services is provided solely by the network node serving the user who has invoked the service. The information about, e.g., an explicit call transfer invocation is reported only in the network node serving the transferor of the calls, but no information is available about the other party that are subject to such an operation.

As further examples, in mobile networks comprising an IP Multimedia Subsystem (IMS) layer, which is an architectural framework for delivering IP multimedia to mobile subscribers, the information not present in the charging interface using the Diameter protocol regards dialogue data, redirection, session transfer procedures, and some routing information. For instance, the method “180 ringing” is not reported in the charging Diameter protocol, and this prevents from setting the dialogue state to “B alerted”. Also the Privacy header field, which is used for user identification restriction services, is not provided in the charging Diameter protocol. Similarly, in case of redirection in IMS, the returned message “181 Call is being forwarded” is not reported in the charging Diameter protocol, as well as the relevant fields Refer-to and Refer-by.

For this reason, the information provided for charging purposes would not be completely acceptable from the DR point of view, because information of no interest for charging may have significant value for a lawful authority during an investigation.

### SUMMARY

The aim of the present invention is to provide a solution which overcomes the above drawbacks.

This aim and other objects which will become better apparent hereinafter are achieved by a method for providing a lawful requesting authority with retained data related to a communication session of a telecommunications network. It is first of all provided at least one Data Retention Source (DRS) in the telecommunications network which is configured as a Diameter client. A Data Retention (DR) system is also provided which is adapted to communicate with the DRS and is configured as a Diameter server or is in communication with a mediation function acting as a Diameter server for the Data Retention Source. In this scenario, the DRS generates at least one report containing data related to the communication session and sends such report to the DR system as a Diameter message, using a Diameter DR application protocol. Then, the report is stored at the DR system for later retrieval by the lawful requesting authority.

The data related to the communication session may contain data of a respective signaling message related to the communication and generated and/or received by the DRS. The signaling message may be a Session Initiation Protocol (SIP) message. Therefore, each SIP method may be reported individually to the DR system.

As an alternative, the report may be an aggregated report containing all data related to the communication, such as all the data related to a multimedia dialogue. Otherwise, such all data related to the communication may be the data exchanged during a predetermined time interval by the node acting as DRS.

The data related to the communication session may be in the form of an Attribute-Value Pair (AVP) and comprises at least one of user authentication information, service specific authorization information, exchanging resource usage information, relaying, proxying and redirecting of Diameter messages, data to trace and identify the source of the communication, data to identify the destination of the communication, data to identify the date, time and duration of the communication, data to identify the type of the communication, data to identify users' communication equipment or what purports to be their equipment, data to identify the location of mobile communication equipment, or any other data not necessarily required by EU directive 2006/24/EC but possibly required by market specific requirements, e.g. amount of exchanged data.

The DRS may be an IP Multimedia Subsystem node selected among a Proxy Call Session Control Function (P-CSCF), an Interrogating Call Session Control Function (I-CSCF), a Serving Call Session Control Function (S-CSCF), a Media Resource Function (MRF). The DRS may also be any other node, such as a Service node selected among a Short Message Service Center (SMS-C), a Multi-Media Center (MMC), an application server, or a server already supporting a Diameter charging interface.

The aim and the objects of the invention are also achieved by a telecommunications network comprising at least one DRS and a DR system adapted to communicate with the DRS and with a lawful requesting authority. The DRS is configured as a Diameter client and the DR system is configured as a Diameter server or is in communication with a mediation function acting as a Diameter server for the Data Retention Source. The DRS comprises means for generating at least one report containing data related to a communication session and means for sending such report to the DR system as a Diameter message, using a Diameter DR application protocol.

A node of the telecommunications network is also provided. Such node is configured to operate as a DRS and is adapted to generate at least one report containing data which is available to the node and regards a communication session, and to communicate with a DR system. Such node is configured as a Diameter client and comprises means for sending such report to the DR system as a Diameter message, using a Diameter DR application protocol.

According to another aspect of the invention, a DR system for receiving data related to a communication session from a DRS is provided. Such DR system comprises a storage for retaining the data from the DRS and at least one handover interface for providing the retained data to a lawful requesting authority. The DR system comprises a server running a Diameter application for receiving at least one Diameter message from the DRS which comprises at least one report containing such data related to the communication session.

A computer program loadable into a processor of a DRS node is also provided. The computer program comprises code suitable to generate at least one report containing data available to the DRS node and related to a communication session and to send the report to a DR system as a Diameter message, using a Diameter DR application protocol.

### BRIEF DESCRIPTION OF THE DRAWINGS

Further characteristics and advantages of the invention will become better apparent from the detailed description of particular but not exclusive embodiments, illustrated by way of non-limiting examples in the accompanying drawings, wherein:

FIG. 1 is a known arrangement of DR system;

FIG. 2 is a block diagram of Diameter applications based on a Diameter base protocol;

FIG. 3 is a schematic overview of a Diameter DR application based on a Diameter base protocol according to the present invention;

FIG. 4 is a schematic overview of a DR system according to the present invention;

FIG. 5 is a flow diagram of the operation of collecting data from a call session according to a first embodiment of invention;

FIG. 6 is a flow diagram of the operation of collecting data from a call session according to a second embodiment of invention.

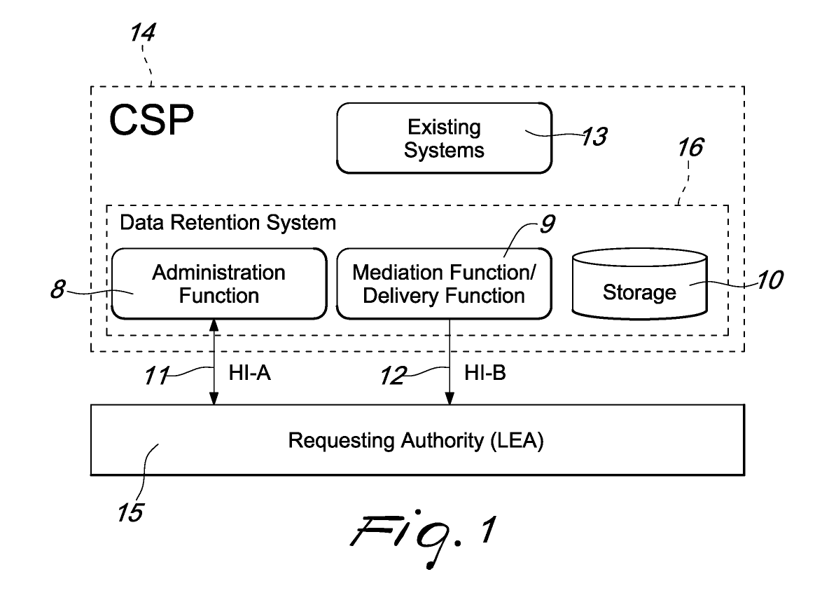

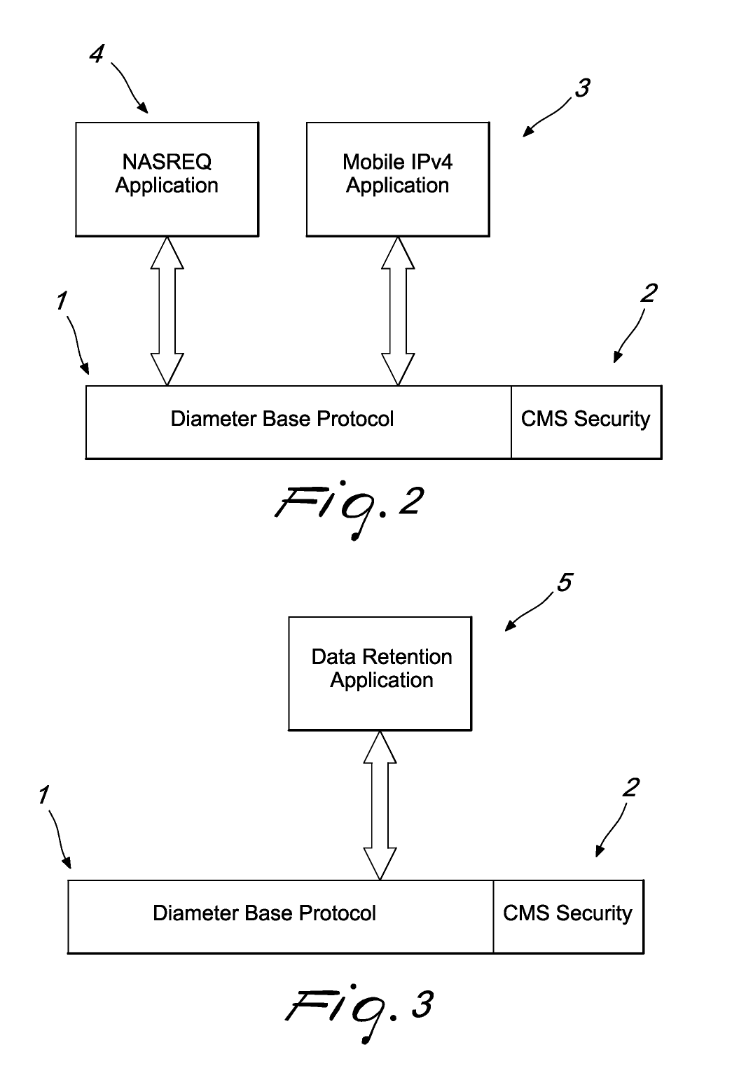

### DETAILED DESCRIPTION

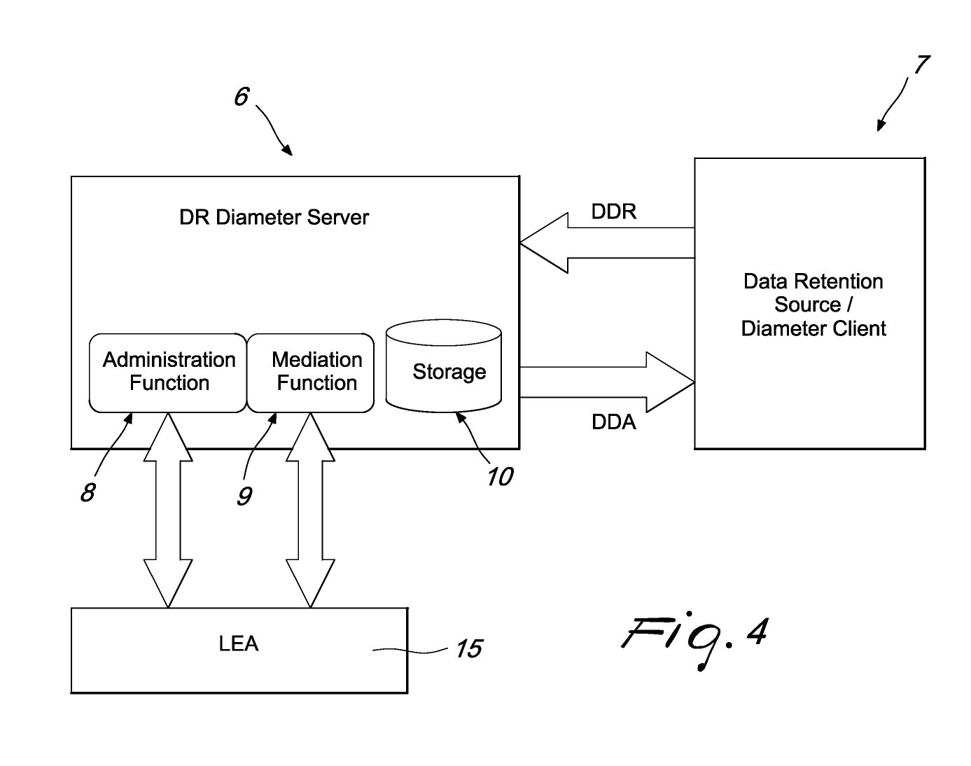

With reference to FIG. 3, the method according to the invention is based on a Diameter Base Protocol 1, in which basic functionality common to all applications and services is implemented, and on a Diameter Data Retention (DR) Application 5, in which specific DR functionality is implemented.

The base Diameter protocol concerns itself with delivery of AVPs (attribute-value pairs), capabilities negotiation, error notification, extensibility through addition of new commands and AVPs, and basic services necessary for applications, such as handling of user sessions.

The Diameter DR application 5, instead, is a protocol which is used between each Data Retention Source (DRS) of the network and the DR system for communicating data records relating to a communication session (call and/or service). The DRS 7 is configured to send records to the DR system which relate to all communications received, forwarded or generated by the node acting as DRS 7 and involving all users. Then, the lawful requesting authority may request retained data of a particular target user to the DR system.

The Diameter base protocol 1 and the Diameter DR application 5 are installed both in at least one node 7 of the telecommunications network which acts as DRS and in the DR system 6, which is responsible for the collection and storage of retained data and for communication of such data to a requesting authority 15 such as a LEA (Law Enforcement Agency).

The DRS 7 and the DR system 6 are configured to act as Diameter client and Diameter server, respectively, which particularly exchange Diameter messages not to request/grant AAA services for the user, but only for reporting/storing call- or service-related data of the user involved in a certain communication session.

As an alternative, a mediation function entity which acts as Diameter server may be provided between the DRS 7 and the DR system 6. Such mediation function would be configured to receive Diameter messages from the DRS 7 and send data records to the DR system 6.

As shown in FIG. 4, the Diameter DR. application 5 is preferably based on two Diameter messages: DDR (Data retention related Data Request) for reporting data relating to a communication session involving at least one user, and DDA (Data retention related Data Answer) for acknowledging receipt of such data. The data to be reported may be the same which can be already reported via the Diameter charging protocol arid which is of interest for data retention purposes, plus other data which is normally not reported via the Diameter charging protocol, such as the data already discussed here above in the background art section.

Further messages for reporting or acknowledging receipt of aggregated data records which are issued by the DRS 7 at the end of a communication session or at the end of a predetermined time period may be also provided, as it will be discussed with reference to FIG. 6.

The DR system 6 includes modules for collecting, storing and delivering communication data generated by DRS nodes of the telecommunications network. The DR system 6 comprises an Administration Function 8 for handling administrative, request and response information for a requesting authority (LEA) 15. A Mediation Function 9 is also configured in the ARDS for transporting any retained data information stored in a repository or storage 10 towards the requesting authority 15.

The DRS 7 is a network node which is configured to generate reports relating to a communication session involving the user, for DR purposes, and to send such reports to the DR system 6 via Diameter messages, such as DDR messages. The reports may contain data to trace and identify the source of the communication involving the user, data to identify the destination of the communication, data to identify the date, time and duration of the communication, data to identify the type of the communication, data to identify users' communication equipment or what purports to be their equipment, and/or data to identify the location of mobile communication equipment.

The DDR messages provide such reports in the form of AVPs and may also contain information for supporting the following features:
transporting of user authentication information, for the purposes of enabling the Diameter Server 6 to authenticate the user;
transporting of service specific authorization information, between client and servers, allowing the peers to decide whether a user's request should be granted;
exchanging resource usage information, which may be used for accounting/billing purposes, capacity planning, etc;
relaying, proxying and redirecting of Diameter messages through a server hierarchy.

The DRS 7 is preferably an IP Multimedia Subsystem (IMS) node such a Proxy Call Session Control Function (P-CSCF), an Interrogating Call Session Control Function (I-CSCF), a Serving Call Session Control Function (S-CSCF), a Media Resource Function (MRF).

The DRS 7 may also be a Service node selected among a Short Message Service Center (SMS-C), a Multi-Media Center (MMC), an application server, a server already supporting a Diameter charging interface, or any node of legacy systems, such as a local exchange, a narrowband telephony server or an MSC server.

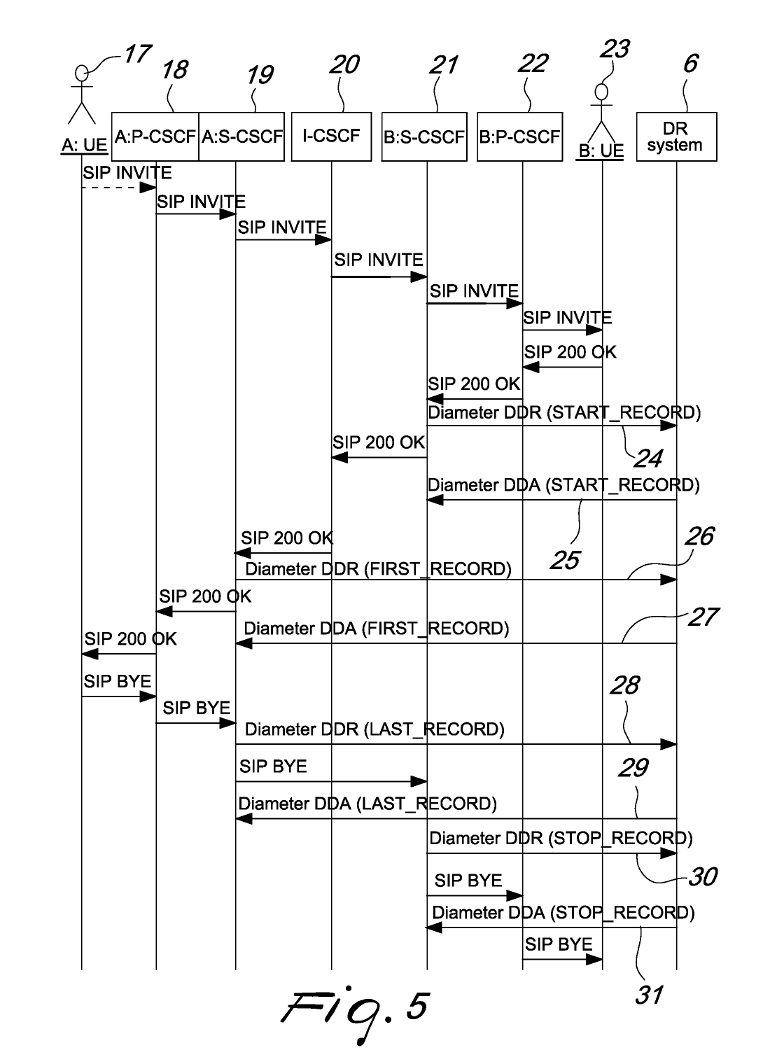

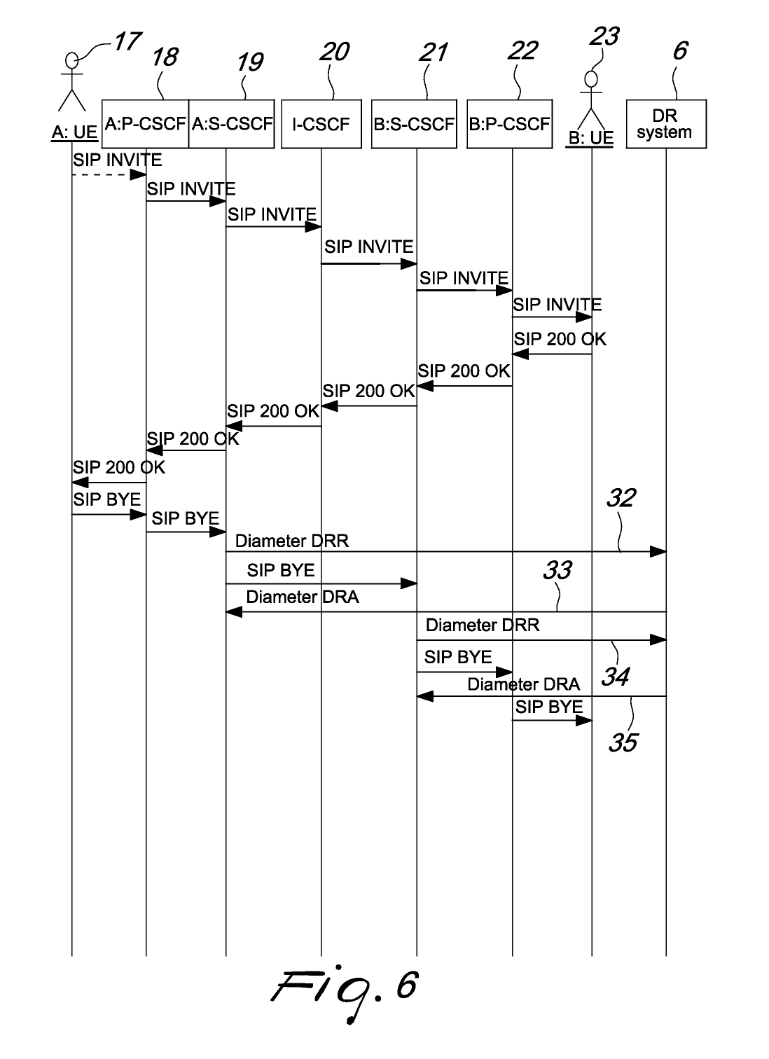

FIG. 5 illustrates a first embodiment of the present invention applied to networks comprising an IMS layer, where the DRSs are both the originating and the terminating S-CSCFs. In the first embodiment, each signaling message, in particular each Session Initiation Protocol (SIP) method, is reported individually to the DR system 6.

The originating network comprises an originating IMS user equipment 17, an originating P-CSCF 18 and an originating S-CSCF 19. Similarly, the terminating network comprises a terminating S-CSCF 21, a terminating P-CSCF 22 and a destination IMS user equipment 23. An I-CSCF 20 is also provided as an interface between the S-CSCFs of the two (A- and B-) networks, in order to retrieve the destination user location from the Home Subscriber Server (HSS) and then route the SIP requests to the assigned S-CSCF 21.

Both of the originating S-CSCF 19 and the terminating S-CSCF 21 are configured as Diameter clients, while the DR system 6 is the corresponding Diameter server.

When the User Equipment (UE) 17 initiates a communication session to establish a connection with another party 23, the user endpoint 17 generates a SIP INVITE message which is sequentially forwarded via the originating P-CSCF 18, the originating S-CSCF 19, the I-CSCF 20, the terminating S-CSCF 21, the terminating P-CSCF, to the destination UE 23.

Upon reception of the SIP 200 OK message from the P-CSCF 22, in response to the destination UE 23 accepting the communication, the Diameter DR application at the terminating S-CSCF 21 generates a DDR message 24, START_RECORD, to record at the DR system 6 start of a communication session.

It is to be noted that the START_RECORD DDR message may be generated in different situations, depending on the requirements of the data retention solution. For instance, the message may be generated as soon as provisional responses such as the 183 SIP method are sent by the DRS to the next node.

Then, the Diameter server DR system 6 responds with a DDA message 25 acknowledging the receipt of the START_RECORD message to the S-CSCF 20. When the originating S-CSCF 19 receives the SIP 200 OK message from the I-CSCF 20 and forwards the message to the P-CSCF 18, it provides the DR system 6 with the currently available data which relates to the communication originated by the UE 17, via a DDR FIRST_RECORD message 26. Such data may contain the report of the SIP messages SIP 200 OK received from the I-CSCF 20 and forwarded to the P-CSCF 18.

In the meantime, the SIP 200 OK message reaches the originating UE 17, which can definitely initiate the communication session with the UE 23. During such communication session, the originating S-CSCF 19 may send further Diameter DDR messages to the DR system, for reporting any other SIP messages exchanged with the CSCFs 18 and 20 or other data relating to the communication session. For instance, an INTERIM_RECORD DDR message may be sent by the S-CSCF 19 to record at the DR system 6 a modification of a media component in the S-CSCF 19.

It is to be noted that each time a DDR message is sent by a CSCF to the DR system 6, a corresponding acknowledgement message DDA is sent back to the CSCF. For instance, for confirming safe receipt of the START_RECORD message, the DR system may send to the S-CSCF 19 a DDA message 27 specific to the START_RECORD.

Once the originating UE 17 disconnects, it sends a SIP BYE message to the S-CSCF 19 via the P-CSCF 18. The S-CSCF accordingly sends a corresponding report to the DR system 6 via a Diameter DDR message LAST_RECORD 28 and the DR system 6 responds with a DDA message LAST_RECORD 29.

Once the SIP BYE message arrives at the terminating S-CSCF 21, a Diameter DDR STOP_RECORD 30 is submitted by the S-CSCF 21 to the DR system 6 to record stop of the communication session.

The DR system 6 responds with a Diameter DDA message STOP_RECORD 31 and proceeds to aggregate the data received by the S-CSCFs during the entire communication session and to store such data in the repository 10 as retained data for future retrieval by the LEA 15.

FIG. 6 shows a similar communication session flow with the same initiating SIP INVITE messages as in FIG. 5. The SIP INVITE messages are sent to the different nodes 18-22 towards the recipient 23 and SIP 200 OK messages are sent back to the session initiator UE 17.

Once the UE 17 terminates the session a SIP BYE message is received, the originating S-CSCF 19 generates an aggregate report of all data relating to the communication session available to the S-CSCF 19 and forwards the report via a Diameter DRR (Data retention related Record Request) message 32 to the DR system 6 for storage. The DR system 6 responds with a DRA (Data retention related Record Answer) message 33 acknowledging the receipt of the aggregate data report.

Similarly, the terminating S-CSCF 21 also sends an aggregate data report via the Diameter DRR message 34 to the DR system 6, as soon as the SIP BYE message is received. The Diameter DRA message 35 from the DR system informs the S-CSCF 21 of the safe receipt of the aggregate report.

Then, the aggregate data will be stored at the DR system 6, for future retrieval by the LEA 15.

In case the session is set for a long time period, the S-CSCFs 19 and 21 can be configured to generate reports after predetermined time intervals, so that aggregated partial data is periodically reported to the DR system 6.

The above described methods are not limited to IMS nodes, but they can also be applied to different types of node, such as application servers that are already supporting the Diameter charging interface.

It has been shown that the invention fully achieves the intended aim and objects, since it provides a data retention method and system with a complete set of data of a telecommunication session and fulfils any data retention requirement in terms of relevant traffic cases and data to retain.

Advantageously, the re-use of Diameter base protocol in the DRSs limits impacts on the traffic nodes.

Moreover, since the Diameter DR application uses a standardized Diameter base protocol, it is possible to support multiple DRSs and/or DR systems from different vendors.

Furthermore, the interfaces used for charging and the ones used for data retention are completely separated making them independent and no changes to the charging configuration has to be carried out.

Clearly, several modifications will be apparent to and can be readily made by the skilled in the art without departing from the scope of the present invention. Therefore, the scope of the claims shall not be limited by the illustrations or the preferred embodiments given in the description in the form of examples, but rather the claims shall encompass all of the features of patentable novelty that reside in the present invention, including all the features that would be treated as equivalents by the skilled in the art.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. A method for providing a lawful requesting authority with retained data related to a communication session of a telecommunications network, comprising the steps of:
providing at least one Data Retention Source in the telecommunications network, said Data Retention Source being configured as a Diameter client by installing a Diameter base protocol and a Diameter application protocol for communicating data related to communication sessions;
providing a Data Retention system adapted to communicate with said at least one Data Retention Source, said Data Retention system being configured as a Diameter server by installing said Diameter base protocol and said Diameter application protocol, or being in communication with a mediation function acting as said Diameter server for the Data Retention Source;
generating records, at said at least one Data Retention Source, which relate to all communications received, forwarded or generated by the Data Retention Source and involving all users;
sending said records from said Data Retention Source to the Data Retention system as Diameter messages, using said Diameter application protocol; and,
storing said records at the Data Retention system for later retrieval of retained data of a target user involved in a communication session by the lawful requesting authority.

2. The method of claim 1, wherein said data related to the communication sessions contains data of a respective signaling message related to the respective communication and generated and/or received by the Data Retention Source.

3. The method of claim 1, wherein said records are aggregated reports containing all data related to the communications.

4. The method of claim 3, wherein said all data related to the communications is the data exchanged during a predetermined time interval by the node acting as Data Retention Source.

5. The method of claim 3, wherein said data is in the form of an Attribute-Value Pair (AVP) and comprises at least one of:
user authentication information;
service specific authorization information;
exchanging resource usage information;
relaying, proxying and redirecting of Diameter messages;
data to trace and identify the source of the communication;
data to identify the destination of the communication;
data to identify the date, time and duration of the communication;
data to identify the type of the communication;
data to identify users' communication equipment or what purports to be their equipment; and,
data to identify the location of mobile communication equipment.

6. The method of claim 2, wherein the signaling message is a Session Initiation Protocol message.

7. The method of claim 1, wherein the at least one Data Retention Source is one or more of:
an IP Multimedia Subsystem node selected among a Proxy Call Session Control Function (P-CSCF), an Interrogating Call Session Control Function (I-CSCF), a Serving Call Session Control Function (S-CSCF), a Media Resource Function (MRF);
a Service node selected among a Short Message Service Center (SMSC), a Multi-Media Center (MMC), an application server; and,
a server supporting a Diameter charging interface.

8. A telecommunications network comprising at least one Data Retention Source and a Data Retention system adapted to communicate with the Data Retention Source and with a lawful requesting authority, characterized in that said Data Retention Source is configured as a Diameter client by having installed a Diameter base protocol and a Diameter application protocol for communicating data related to communication sessions and said Data Retention system is configured as a Diameter server by installing said Diameter base protocol and said Diameter application protocol or is in communication with a mediation function acting as said Diameter server for the Data Retention Source, said at least one Data Retention Source comprising means for generating records which relate to all communications received, forwarded or generated by the Data Retention Source and involving all users and means for sending said records to the Data Retention system as Diameter messages, using said Diameter application protocol, said Data Retention system having said records stored for later retrieval of retained data of a target user involved in a communication session by the lawful requesting authority.

9. The network of claim 8, wherein said data related to the communication sessions contains data of a respective signaling message related to the respective communication and generated and/or received by the Data Retention Source.

10. The network of claim 8, wherein said records are aggregated reports containing all data related to the communications.

11. The network of claim 10, wherein said all data related to the communications is the data exchanged during a predetermined time interval by the node acting as Data Retention Source.

12. The network of claim 10, wherein said data is in the form of an Attribute-Value Pair (AVP) and comprises at least one of:
user authentication information;
service specific authorization information;
exchanging resource usage information;
relaying, proxying and redirecting of Diameter messages;
data to trace and identify the source of the communication;
data to identify the destination of the communication;
data to identify the date, time and duration of the communication;
data to identify the type of the communication;
data to identify users' communication equipment or what purports to be their equipment; and,
data to identify the location of mobile communication equipment.

13. The network of claim 9, wherein the signaling message is a Session Initiation Protocol message.

14. The network of claim 8, wherein the at least one Data Retention Source is one or more of:
an IP Multimedia Subsystem node selected among a Proxy Call Session Control Function (P-CSCF), an Interrogating Call Session Control Function (I-CS, CF), a Serving Call Session Control Function (S-CSCF), a Media Resource Function (MRF);
a Service node selected among a Short Message Service Center (SMSC), a Multi-Media Center (MMC), an application server; and, a server supporting a Diameter charging interface.

15. A node of a telecommunications network which is configured to operate as a Data Retention Source, said node being adapted to generate records which relate to all communications received, forwarded or generated by the Data Retention Source and involving all users and to communicate with a Data Retention system, characterized in that said node is configured as a Diameter client by having installed a Diameter base protocol and a Diameter application protocol for communicating said records and comprises means for sending said records to the Data Retention system as Diameter messages, using said Diameter application protocol.

16. The node of claim 15, wherein said records contains data of a respective signaling message related to the respective communication and generated and/or received by the node.

17. The node of claim 15, wherein said records are aggregated reports containing all data related to the communications.

18. The node of claim 17, wherein said all data related to the communications is the data exchanged during a predetermined time interval by the node.

19. The node of claim 17, wherein said data is in the form of an Attribute-Value Pair (AVP) and comprises at least one of:
user authentication information;
service specific authorization information;
exchanging resource usage information;
relaying, proxying and redirecting of Diameter messages;
data to trace and identify the source of the communication;
data to identify the destination of the communication;
data to identify the date, time and duration of the communication;
data to identify the type of the communication;
data to identify users' communication equipment or what purports to be their equipment; and,
data to identify the location of mobile communication equipment.

20. The node of claim 16, wherein the signaling message is a Session Initiation Protocol message.

21. The node of claim 15, characterized in that the node is one of:
an IP Multimedia Subsystem node selected among a Proxy Call Session Control Function (P-CSCF), an Interrogating Call Session Control Function (I-CSCF), a Serving Call Session Control Function (S-CSCF), a Media Resource Function (MRF);
a Service node selected among a Short Message Service Center (SMSC), a Multi-Media Center (MMC), an application server; and,
a server supporting a Diameter charging interface.

22. A Data Retention system for receiving data related to communication sessions from a Data Retention Source, said Data Retention system comprising a storage for retaining said data from the Data Retention Source and at least one handover interface for providing the retained data of a target user involved in a communication session to a lawful requesting authority, characterized in that said Data Retention system comprises a server running a Diameter base protocol and a Diameter application for receiving Diameter messages from the Data Retention Source comprising records which relate to all communications received, forwarded or generated by the Data Retention Source and involving all users.

23. The system of claim 22, wherein said data related to the communication session contains data of a respective signaling message related to the communication and generated and/or received by the node.

24. The system of claim 22, wherein said records aggregated reports contain all data related to the communication.

25. The system of claim 24, wherein said all data related to the communications is the data exchanged during a predetermined time interval by the node acting as Data Retention Source.

26. The system of claim 24, wherein said data is in the form of an Attribute-Value Pair (AVP) and comprises at least one of:
user authentication information;
service specific authorization information;
exchanging resource usage information;
relaying, proxying and redirecting of Diameter messages;
data to trace and identify the source of the communication;
data to identify the destination of the communication;
data to identify the date, time and duration of the communication;
data to identify the type of the communication;
data to identify users' communication equipment or what purports to be their equipment;
data to identify the location of mobile communication equipment.

27. The system of claim 23, wherein the signaling message is a Session Initiation Protocol message.

28. (canceled)
